(19) United States
(12) Patent Application Publication
(10) Pub. No.: US 2024/0414588 A1
(43) Pub. Date: Dec. 12, 2024

(54) APPARATUS AND METHOD FOR MEASUREMENT REPORTING FOR L1/L2 MOBILITY

(71) Applicant: Nokia Technologies Oy, Espoo (FI)

(72) Inventors: Karri Markus RANTA-AHO, Espoo (FI); Subramanya CHANDRASHEKAR, Bangalore (IN)

(21) Appl. No.: 18/579,773

(22) PCT Filed: Aug. 12, 2022
(86) PCT No.: PCT/IB2022/057572

§ 371 Date: Jan. 16, 2024

(30) Foreign Application Priority Data
Aug. 16, 2021 (IN) 202141037079

(51) Int. Cl. H04W 28/02; H04B 7/06; H04W 36/00

(52) U.S. Cl. CPC H04W 28/0278; H04B 7/0626; H04W 36/0085

(57) ABSTRACT

A method for a network element, NE, is proposed, which comprises receiving from a user equipment, UE, at least one of a BSR or an uplink MAC-CE; determining to perform an L1 based handover for the UE; and sending an L1 based handover command to the UE. Another method for a UE is proposed, which comprises receiving an L1/L2 mobility configuration; deciding that there is an L1 CSI report to send; determining whether the UE has an UL grant; if it is determined that the UE has an UL grant, the method further comprises: sending at least one of a BSR or an UL MAC-CE to a NE; if it is determined that the UE does not have an UL grant, the method further comprises: sending a dedicated SR to a NE indicating that an L1 CSI report is pending; receiving a scheduling grant from the NE; and sending the L1 CSI report to the NE based on the scheduling grant; and receiving an L1 based handover command from the NE.

### CROSS-REFERENCE TO RELATED APPLICATION

This application claims priority from India provisional patent application No. 202141037079 filed on Aug. 16, 2021. The contents of this earlier filed application are hereby incorporated by reference in their entirety.

### TECHNICAL FIELD

The present application relates generally to an apparatus and a method for measurement reporting for L1/L2 mobility.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application.

Certain abbreviations that may be found in the description and/or in the Figures are herewith defined as follows:

| | |
|---|---|
| 3GPP | 3^{rd} Generation Partnership Project |
| 5G | 5^{th} Generation |
| AP | Access Point |
| BSR | Buffer Status Report |
| CE | Control Element |
| CQI | Channel Quality Indication |
| CRI | CSI-RS Resource Indicator |
| CSI | Channel State Information |
| CSI-RS | Channel State Information Reference Signal |
| CU | Central Unit |
| CU-CP | CU Control Plane |
| CU-UP | CU User Plane |
| DCI | Downlink Control Information |
| DL | Downlink |
| DU | Distributed Unit |
| eMBB | enhanced Mobile Broadband |
| eNB | enhanced Node B |
| gNB | 5G Node B |
| HO | Handover |
| ID | Identifier |
| IoT | Internet of Things |
| L1 | Layer 1 |
| L1 RSRP | Layer 1 Reference Signal Received Power |
| L2 | Layer 2 |
| L3 | Layer 3 |
| LCG | Logical Channel Group |
| LTE | Long Term Evolution |
| LTE-A | LTE Advanced |
| M2M | Machine to Machine |
| MAC | Medium Access Control |
| MAC-CE | MAC Control Element |
| mMTC | massive Machine Type Communication |
| NE | Network Element |
| NG | Next Generation |
| NR | New Radio |
| PBCH | Physical Broadcast Channel |
| PDCCH | Physical Downlink Control Channel |
| PDSCH | Physical Downlink Shared Channel |
| PUCCH | Physical Uplink Control Channel |
| PUSCH | Physical Uplink Shared Channel |
| RRC | Radio Resource Control |
| RSRP | Reference Signal Received Power |
| SSB | Synchronization Signal and PBCH Block |
| SSBRI | SSB Resource Indicator |
| TRP | Transmission and Reception Point |
| TSC | Time Sensitive Communications |
| UE | User Equipment |
| UL | Uplink |
| URLLC | Ultra Reliable Low Latency Communication |
| V2D | Vehicle to Device |
| V2V | Vehicle to Vehicle |

LTE is a standard for wireless communication that seeks to provide improved speed and capacity for wireless communications by using new modulation/signal processing techniques. The standard was proposed by the 3GPP. Since its inception, LTE has seen extensive deployment in a wide variety of contexts involving the communication of data. In recent years, the exponential growth of smartphones and the traffic they generate have become a major challenge of the industry. 3GPP has been continuing to alleviate this challenge by enhancing LTE standards to further improve capacity and performance and introducing improvements for system robustness.

3GPP 5G or NG system, may support a number of use cases and features. These use cases are, but not limited to: eMBB and URLLC, as well as mMTC. 5G is mostly built on a NR, but a 5G (or NG) network can also build on LTE radio. NR is expected to deliver extreme broadband and ultra-robust, low latency connectivity and massive networking to support the IoT. With IoT and M2M communication becoming more widespread, there will be a growing need for designs that meet the needs of lower power, high data rate, and long battery life. It is noted that, in 5G, the nodes that can provide radio access functionality to a user equipment (i.e., similar to eNB in LTE) may be named gNB when built on NR radio and may be named NG-eNB when built on LTE radio.

A disaggregated architecture is defined in the 3GPP standard as a decomposition of a gNB into multiple logical entities, including a central unit, CU, and distributed units, DUs. A single DU may host multiple cells. The CU itself is split into a control plane component. CU-CP, and a user plane component, CU-UP. The CU-CP is connected to the CU-UP via an E1 connection, the DUs are connected to the CU-CP via a F1-C connection, and the DUs are connected to the CU-UP via a F1-U connection.

### SUMMARY

According to an example implementation, a method includes receiving from a UE at least one of a BSR, or an uplink MAC-CE; determining to perform an L1 based handover for the UE; and sending an L1 based handover command to the UE.

According to an example implementation, an apparatus includes at least one processor and at least one memory including computer program code, the at least one memory and the computer program code configured to, with the at least one processor, cause the apparatus at least to receive from a UE at least one of a BSR, or an uplink MAC-CE; determine to perform an L1 based handover for the UE; and send an L1 based handover command to the UE.

According to an example implementation, an apparatus includes means for receiving from a UE at least one of a BSR, or an uplink MAC-CE; means for determining to perform an L1 based handover for the UE; and means for sending an L1 based handover command to the UE.

According to an example implementation, a computer program product including a non-transitory computer-readable storage medium and storing executable code that, when executed by at least one apparatus, is configured to cause the at least one apparatus to perform a method including receiving from a UE at least one of a BSR, or an uplink MAC-CE; determining to perform an L1 based handover for the UE; and sending an L1 based handover command to the UE.

According to an example implementation, a method includes receiving an L1/L2 mobility configuration; deciding that there is an L1 CSI report to send; determining whether the UE has an UL grant; if it is determined that the UE has an UL grant, the method further comprises: sending at least one of a BSR or an UL MAC-CE to a NE; if it is determined that the UE does not have an UL grant, the method further comprises: sending a dedicated SR to a NE indicating that an L1 CSI report is pending; receiving a scheduling grant from the NE; and sending the L1 CSI report to the NE based on the scheduling grant; and receiving an L1 based handover command from the NE.

According to an example implementation, an apparatus includes at least one processor and at least one memory including computer program code, the at least one memory and the computer program code configured to, with the at least one processor, cause the apparatus at least to receive an L1/L2 mobility configuration; decide that there is an L1 CSI report to send; determine whether the UE has an UL grant; if it is determined that the UE has an UL grant, the at least one memory and the computer program code configured to cause the apparatus at least to send at least one of a BSR or an UL MAC-CE to a NE; if it is determined that the UE does not have an UL grant, the at least one memory and the computer program code configured to cause the apparatus at least to send a dedicated SR to a NE indicating that an L1 CSI report is pending; receive a scheduling grant from the NE; and send the L1 CSI report to the NE based on the scheduling grant; and receive an L1 based handover command from the NE.

According to an example implementation, an apparatus includes means for receiving an L1/L2 mobility configuration; means for deciding that there is an L1 CSI report to send; means for determining whether the UE has an UL grant; if it is determined that the UE has an UL grant, the apparatus further comprises: means for sending at least one of a BSR or an UL MAC-CE to a NE; if it is determined that the UE does not have an UL grant, the apparatus further comprises: means for sending a dedicated SR to a NE indicating that an L1 CSI report is pending; means for receiving a scheduling grant from the NE; and means for sending the L1 CSI report to the NE based on the scheduling grant; and means for receiving an L1 based handover command from the NE.

According to an example implementation, a computer program product including a non-transitory computer-readable storage medium and storing executable code that, when executed by at least one apparatus, is configured to cause the at least one apparatus to perform a method including receiving an L1/L2 mobility configuration; deciding that there is an L1 CSI report to send; determining whether the UE has an UL grant; if it is determined that the UE has an UL grant, the method further comprises: sending at least one of a BSR or an UL MAC-CE to a NE; if it is determined that the UE does not have an UL grant, the method further comprises: sending a dedicated SR to a NE indicating that an L1 CSI report is pending; receiving a scheduling grant from the NE; and sending the L1 CSI report to the NE based on the scheduling grant; and receiving an L1 based handover command from the NE.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example communication system in which various example embodiments of the application implement.

FIG. 2 is a diagram illustrating a disaggregated gNB architecture according to an example embodiment.

FIGS. 3a and 3b illustrate formats for short BSR/short truncated BSR MAC-CE and long BSR/long truncated BSR, respectively, according to an example embodiment.

FIG. 4 describes a message flow according to an example embodiment.

FIG. 5 describes a message flow according to an example embodiment.

FIG. 6 describes a block diagram for some operation of a UE according to another example embodiment.

FIG. 7 describes a block diagram for some operation of a NE according to an example embodiment.

FIG. 8 illustrates a simplified block diagram of various example apparatuses that are suitable for use in practicing various example embodiments of this application.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for support of measurement reporting for L1/L2 mobility, is not intended to limit the scope of certain embodiments but is representative of selected example embodiments.

The features, structures, or characteristics of example embodiments described throughout this specification may be combined in any suitable manner in one or more example embodiments. For example, the usage of the phrases “an example embodiment” “certain embodiments,” “some embodiments,” or other similar language, throughout this specification refers to the fact that a particular feature, structure, or characteristic described in connection with an embodiment may be included in at least one embodiment. Thus, appearances of the phrases “in an example embodiment”, “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the singular forms “a”, “an” and “the” are intended to include the plural forms as well, unless the context clearly indicates otherwise. The phrase “set of” refers to a set that includes one or more of the referenced set members. As such, the phrases “set of,” “one or more of,” and “at least one of,” or equivalent phrases, may be used interchangeably. Further, “or” is intended to mean “and/or”, unless explicitly stated otherwise.

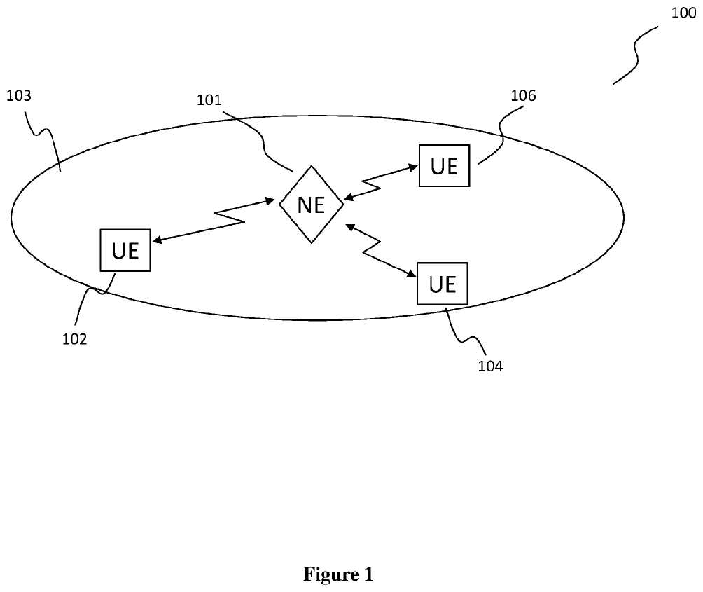

FIG. 1 illustrates an example communication system 100 in which various embodiments of the application can be implemented. The example communication system 100 comprises a NE, 101, such as for example, an AP, an eNB, a gNB or a NG-eNB connecting to a core network that is not shown for brevity. Part of the functionalities of the NE 101 may be also carried out by any node, server or host which may be operably coupled to a transceiver, such as a remote radio head. NE 101 provides wireless coverage within a cell 103, including the UEs 102, 104 and 106. Although just one NE, and three UEs are shown in FIG. 1, it is only for the purpose of illustration and the example communication system 100 may comprise any number of NE(s), and UE(s).

The various example implementations may be applied to a wide variety of wireless technologies, wireless networks, such as LTE, LTE-A, 5G (New Radio, or NR), cmWave, and/or mm Wave band networks, or any other wireless network or use case. LTE, 5G, cmWave and mm Wave band networks are provided only as illustrative examples, and the various example implementations may be applied to any wireless technology/wireless network. The various example implementations may also be applied to a variety of different applications, services or use cases, such as, for example, URLLC, IoT, TSC, eMBB, MMTC, V2V, V2D, etc. Each of these use cases, or types of UEs, may have its own set of requirements.

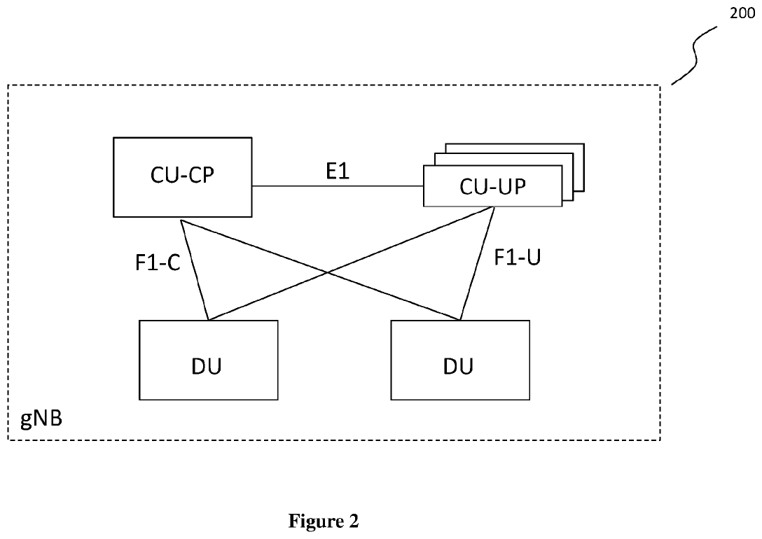

A disaggregated architecture is defined in the 3GPP standard as a decomposition of a gNB into multiple logical entities. FIG. 2 illustrates such an architecture 200, in which a gNB, such as for example, the NE 101 of FIG. 1, has a CU and DUs. As shown in FIG. 2, the CU itself is split into a control plane component, CU-CP, and a user plane component, CU-UP. The CU-CP is connected to the CU-UP via an E1 connection, the DUs are connected to the CU-CP via a F1-C connection, and the DUs are connected to the CU-UP via a F1-U connection.

In such a disaggregated architecture as that shown in FIG. 2, a DU may host multiple cells up to a maximum of 512 according to current 3GPP specifications. Accordingly, serving cell change between cells may be considered intra-DU for a serving cell change between cells of the same DU, and inter-DU between cells of different DUs. The L1/L2 mobility is a new feature being studied in 3GPP. With this feature, the change of serving cell of the UE is not managed by the CU but by the DU. The CU may not be involved in the execution of UE Mobility inside the cells controlled by the DU or between cells of different DUs.

With L1/L2 mobility, when serving cell change is performed by L1/L2 signaling, the source DU may need to identify and differentiate the target DU and the best beam and cell of the target DU from lower layer signaling itself. One solution for this is using CSI reporting. In other words, the source DU may need to be able to determine whether a CSI report, such as for example, a L1 RSRP report, belongs to its own DU/cell or cell of other DUs. However, the mobility measurement reporting is typically done on L3 level only when there is something interesting to report (e.g., configured event like A3/A5 etc), and conventional CSI reporting mechanisms are in one way or another initiated by the network, e.g., gNB.

The CSI reporting typically can take place in three different ways: 1) Periodic CSI reporting where the CSI is reported on the uplink periodically, as configured by RRC, e.g., on a PUCCH resource configured by the RRC or PUSCH resource indicated with UL scheduling grant; 2) Aperiodic CSI reporting, where the CSI is reported on the uplink, based on an event and requested by the gNB on the PUCCH or PUSCH resource indicated together with the report request. A CSI report on PUCCH is requested using DCI on PDCCH, and a CSI report on PUSCH is requested using a MAC-CE delivered on PDSCH. The gNB decision to request the CSI report is up to the gNB internal algorithms; and 3) Semi-persistent CSI reporting, which is similar to the periodic CSI reporting, but can be activated and deactivated dynamically. The gNB decision to activate the semi-persistent reporting is up to the gNB internal algorithms. The main commonality with these three CSI reporting types is that the gNB is in control and is always fully aware of when a CSI report is going to be sent on the UL, on what channel a CSI report is going to be sent on the UL, and on what resources that channel is going to be transmitted. However, a L1 reporting mechanisms may be desired for UE-initiated measurement reporting for L1/L2 mobility.

In an example embodiment, a UE, such as for example, the UE 102, 104 or 106 of FIG. 1, may provide an indication of a pending CSI report via signaling of L1 or L2.

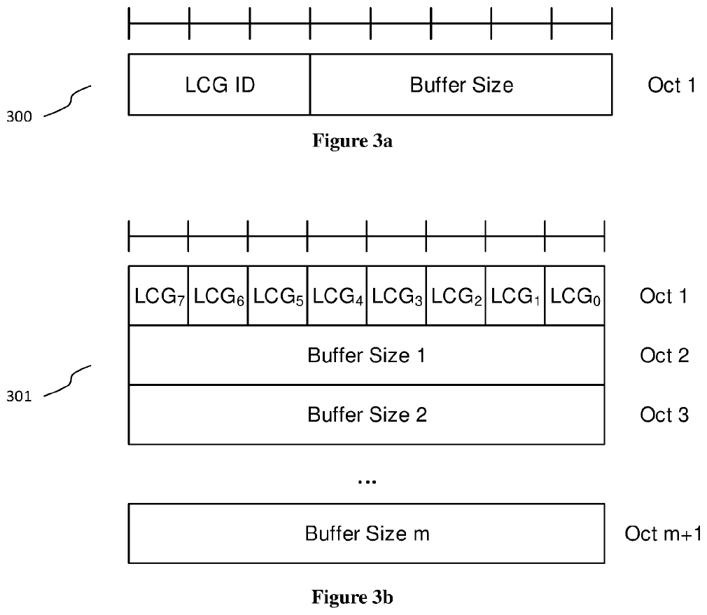

In an example embodiment, the signaling of L1 or L2 may be a buffer status report, BSR, with a designated LCG ID, which indicates that there is a CSI report pending. The UE may send a BSR when there is a pending CSI report triggered by a configured event. The BSR may indicate the pending CSI report with the designated LCG ID and may further use the corresponding buffer size field to provide L1 measurement information for the L1 based handover event to proceed. In an example embodiment, the buffer size field may be used to provide cell indication or beam indication that can uniquely identify the measured cell or beam, or provide further information of the pending CSI report to the gNB/DU. For example, the further information may include the CSI report, e.g., a full or part of a channel measurement metric such as RSRP or CQI, or an indication of the configured event triggering the report. FIGS. 3a and 3b illustrate formats for short BSR/short truncated BSR MAC-CE, and long BSR/long truncated BSR MAC-CE, respectively, according to an example embodiment.

In an example embodiment, the signaling of L1 or L2 may be a UL MAC-CE for CSI reporting. The UL MAC-CE may include the CSI report, e.g., a full or part of a channel measurement metric such as RSRP or CQI, or an indication of the configured event triggering the report, or provide cell indication or beam indication that can uniquely identify the measured cell or beam.

In an example embodiment, if the UE has an uplink grant, it may transmit the BSR or the UL MAC-CE with the resource indicated by the uplink grant; If the UE does not have an uplink grant, the UE may transmit a scheduling request, SR, which will trigger the gNB to schedule PUSCH that will be used to deliver the pending CSI report.

In an example embodiment, the SR is a dedicated SR indicating that a CSI report is pending so that a lower-latency solution can be achieved. When configuring L1/L2 mobility, the CU via RRC may configure a dedicated SR resource for this purpose. For example, a dedicated LCG ID may be configured and when a SR identifies the dedicated LCG ID, it indicates there is a pending CSI report. In another example, a dedicated time/frequency domain resource may be configured for transmitting the SR indicating pending CSI report. Based on the received SR, the gNB may then either trigger an aperiodic CSI request for the pending CSI report, or schedule a PUSCH that can be used to deliver the CSI report.

In an example embodiment, a higher layer, such as for example RRC layer, may configure a set of CSI-RS resources or SSB resources for the UE to measure and define the triggering criteria, and when at least one of the configured criterion is met, the UE may trigger a transmission of the BSR, UL MAC-CE, or dedicated SR.

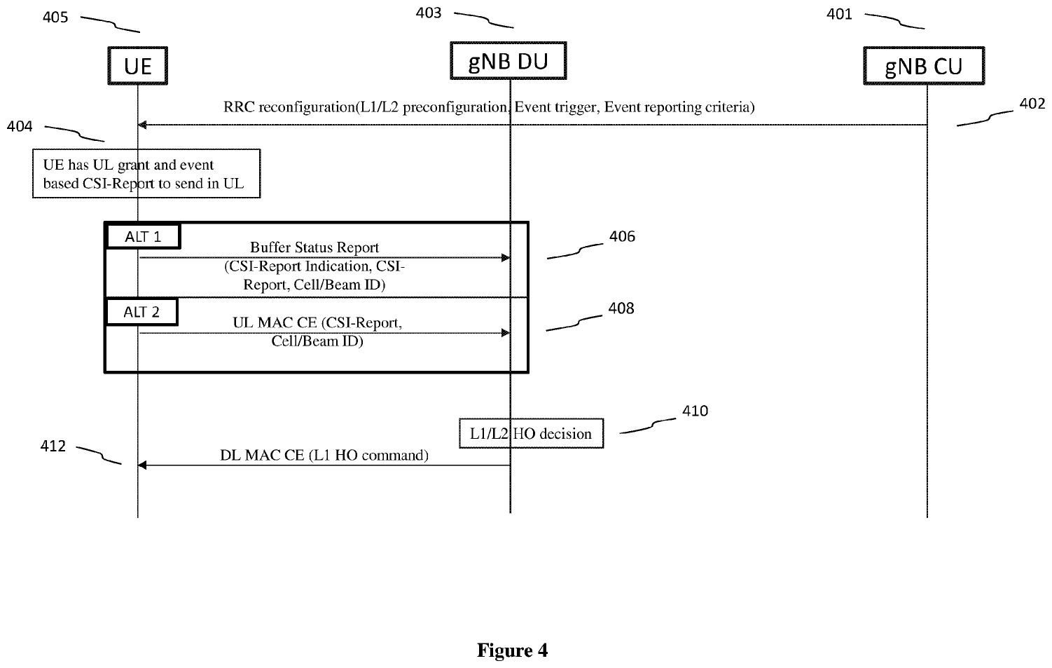

A flow of procedures for a gNB CU 401, a DU 403, and a UE 405 according to an example embodiment is presented in FIG. 4. In the example of FIG. 4, the CU 401, such as for example, the NE 101 of FIG. 1, may send to the UE 405, such as for example, UE 102, 104 or 106 of FIG. 1, L1/L2 mobility configuration via such as for example, a RRC reconfiguration message at 402. The L1/L2 mobility configuration may include L1/L2 preconfiguration, an event that can trigger the measurement report, and an event reporting criteria. In an example embodiment, the L1/L2 preconfiguration may include an indication to perform L1 measurements, or a configuration to be applied at the target cell when the DU sends a DL MAC-CE to execute the serving cell change.

If at 404, the UE 405 has an UL grant and an event-based CSI report to send on UL, the UE may send a BSR to the DU 403 at 406, or send an UL MAC-CE to the DU 403 at 408. In an example embodiment, the BSR may have a designated LCG ID that indicates a pending CSI report. The BSR may indicate the pending CSI report with the designated LCG ID and may further use the corresponding buffer size field to provide L1 measurement information for the L1 based handover event to proceed. In an example embodiment, the buffer size field may be used to provide cell indication or beam indication that can uniquely identify the measured cell or beam, or provide further information of the pending CSI report to the gNB/DU. For example, the further information may include the CSI report, e.g., a full or part of a channel measurement metric such as RSRP or CQI, or an indication of the configured event triggering the report. In an example embodiment, the UL MAC-CE may include the CSI report, e.g., a full or part of a channel measurement metric such as RSRP or CQI, or an indication of the configured event triggering the report, or provide cell indication or beam indication that can uniquely identify the measured cell or beam. In an example embodiment, the BSR and the UL MAC-CE may be used in combination. For example, the BSR may indicate there is a CSI report pending and provide cell or beam indication, while the UL MAC-CE may include the CSI report.

After receiving the BSR or UL MAC-CE from the UE, the DU at 410 may decide to perform a L1/L2 handover and send an L1 based HO command to the UE at 412 via such as for example, a DL MAC-CE.

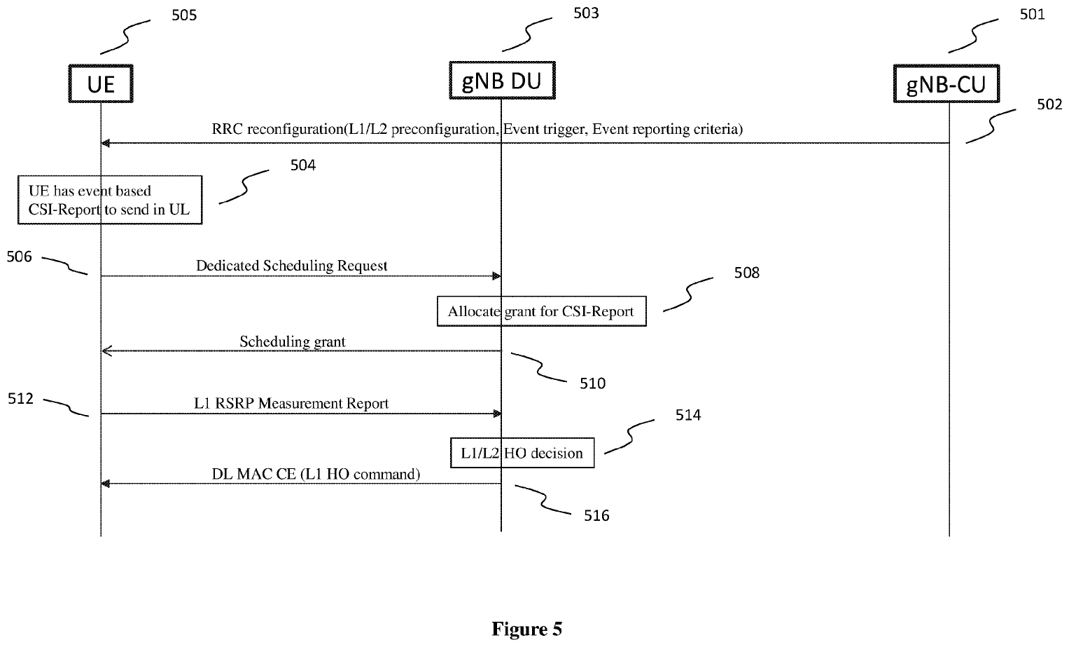

FIG. 5 describes a flow of procedures for a gNB CU 501, a DU 503, and a UE 505 according to an example embodiment. In the example of FIG. 5, the CU 501, such as for example, the NE 101 of FIG. 1, may send to the UE 505, such as for example, UE 102, 104 or 106 of FIG. 1, L1/L2 mobility configuration via such as for example, a RRC reconfiguration message at 502. The L1/L2 mobility configuration may include L1/L2 preconfiguration, an event that can trigger the measurement report, and an event reporting criteria. In an example embodiment, the L1/L2 preconfiguration may include an indication to perform L1 measurements, or a configuration to be applied at the target cell when the DU sends a DL MAC-CE to execute the serving cell change.

If at 504, the UE 505 has an event-based CSI report to send in UL but does not have an UL grant, the UE may send a dedicated SR to the DU 503 at 506. The dedicated SR indicates that an L1 CSI report is pending. In an example embodiment, a dedicated LCG ID may be configured and when a SR identifies the dedicated LCG ID, it indicates there is a pending CSI report. In another example embodiment, a dedicated time/frequency domain resource may be configured for transmitting the SR indicating pending CSI report. After receiving the dedicated SR, the DU may allocate UL grant at 508 and send the scheduling grant to the UE at 510. The scheduling grant may either trigger an aperiodic CSI request for the pending CSI report, or perhaps schedule a PUSCH that can be used to deliver the CSI report, e.g., via a BSR/UL MAC-CE. Either way, the L1 measurement report such as for example, the L1 RSRP measurement report, can be sent from the UE to the DU at 512. Based on the L1 measurement report, the DU may at 514 decide to perform a L1/L2 handover and send the L1 based HO command to the UE at 516 via such as for example, a DL MAC-CE.

In an example embodiment, the CSI report for the cell other than the serving cell for L1/L2 mobility may be used to identify the neighboring cell or the beam being reported. This measurement report provided over L1/L2 may be used by the DU to make the handover decision at 410 or 514.

In an example embodiment, a cell identifier is introduced as a separate field in the L1 CSI report, such as for example, the L1 RSRP CSI report. The cell identifier maps to a configured cell to measure, and multiple cell identifiers can be included in the order of cells that are in the configured set of cells for measurement. An example table of fields of L1 CSI report is illustrated as below in Table 1:

TABLE 1
CRI, SSBRI, and RSRP

| Field | Bitwidth |
|---|---|
| CRI | [log₂(K_{s,l}^{CSI-RS})] |
| SSBRI | [log₂(K_{s,l}^{SSB})] |
| RSRP | 7 |
| Differential RSRP | 4 |
| Cell identifier | [log₂(Kₛ^{Cell})] |

In Table 1, Kₛ^{Cell} is the number of cells in the configured set of cells to measure, while K_{s,l}^{CSI-RS} and K_{s,l}^{SSB} are the numbers of CSI-RS resources and SSB resources in the I-th cell, respectively. One of the CRI and SSBRI may be set to zero and another to an indicator of a signal, e.g., CSI-RS or SSB of the measured cell according to whether the UE is configured to measure CSI-RS or SSB for the cell to be reported. Then an example of L1 CSI report for a set of four beams can be constructed as below in Table 2:

TABLE 2
Mapping order of CSI fields of one report
for CRI/RSRP or SSBRI/RSRP reporting

| | CSI fields |
|---|---|
| CSI report | CRI or SSBRI #1 as in Table 1, if reported |
| | CRI or SSBRI #2 as in Table 1, if reported |
| | CRI or SSBRI #3 as in Table 1, if reported |
| | CRI or SSBRI #4 as in Table 1, if reported |
| | RSRP #1 as in Table 1, if reported |
| | Differential RSRP #2 as in Table 1, if reported |
| | Differential RSRP #3 as in Table 1, if reported |
| | Differential RSRP #4 as in Table 1, if reported |
| | Cell identifier #1 as in Table 1, if reported |
| | Cell identifier #2 as in Table 1, if reported |
| | Cell identifier #3 as in Table 1, if reported |
| | Cell identifier #4 as in Table 1, if reported |

The above tables provide an example L1 RSRP CSI report that allows for providing cell identification for the cell RSRP reporting. Note that in this example, differential RSRPs are reported for cell #2, #3 and #4. In some example embodiment, the full RSRP values may be included.

In an example embodiment, a cell identifier can be integrated as part of the CRI or SSBRI, so that when the UE indicates a particular CSI-RS resource or SSB resource, that indication already implicitly includes the cell identifier. In an example embodiment, the CRI or SSBRI can concatenate a cell-specific beam identifier and a cell identifier, e.g., x bits for beam ID and y bits for cell ID. In another example embodiment, when integrating a cell identifier with the CRI or SSBRI, there can be a single resource identifier that directly identifies the beam and also the cell. An example table of fields of L1 CSI report for integrated cell identifier can be illustrated as below in Table 3:

TABLE 3
CRI, SSBRI, and RSRP

| Field | Bitwidth |
|---|---|
| CRI | ┌log₂ (Σₗ₌₁^{K}_{ₛ}^{^{Cell}} K_{s, l}^{CSI-RS})┐ |
| SSBRI | $⌈ {log}_{2} ( {\sum }_{l = 1}^{{K}_{s}^{Cell}} {K}_{s , l}^{SSB} ) ⌉$ |
| RSRP | 7 |
| Differential | 4 |
| RSRP | |

In Table 3, the CRI field is an integration of the CSI-RS identifier and the cell identifier, and the SSBRI field is an integration of the SSB identifier and the cell identifier.

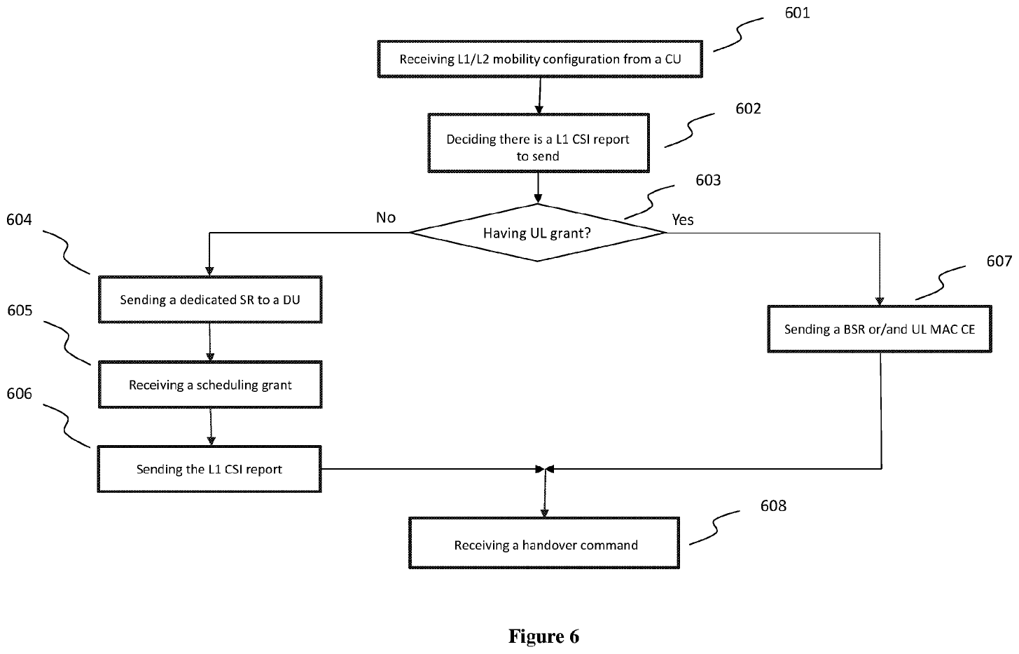

FIG. 6 describes a block diagram for some operation of a UE according to an example embodiment. In FIG. 6, a UE, such as for example, the UE 102, 104, or 106 of FIG. 1, or UE 405 of FIG. 4, or UE 505 of FIG. 5, may receive at 601 from a CU, such as for example, NE 101 of FIG. 1, CU 401 of FIG. 4 or CU 501 of FIG. 5, an L1/L2 mobility configuration via such as for example, a RRC reconfiguration message. The L1/L2 mobility configuration may include L1/L2 preconfiguration, an event that can trigger the measurement report, and an event reporting criteria. In an example embodiment, the L1/L2 preconfiguration may include an indication to perform L1 measurements, or a configuration to be applied at the target cell when the DU sends a DL MAC-CE to execute the serving cell change.

At 602, the UE may decide that there is an L1 CSI report, such as for example, an L1 RSRP measurement report, to send. The UE may determine whether it has an UL grant at 603. In an example embodiment, if it is determined that the UE does not have an UL grant, the UE may at 604 send a dedicated SR to a DU, such as for example, NE 101 of FIG. 1, the DU 403 of FIG. 4 or the DU 503 of FIG. 5. The dedicated SR indicates an L1 CSI report, such as for example, an L1 RSRP measurement report, is pending. In an example embodiment, a dedicated LCG ID may be configured and when a SR identifies the dedicated LCG ID, it indicates there is a pending CSI report. In another example embodiment, a dedicated time/frequency domain resource may be configured for transmitting the SR indicating pending CSI report. At 605, the UE may receive a scheduling grant from the DU. The scheduling grant may either trigger an aperiodic CSI request for the pending L1 CSI report, or perhaps schedule a PUSCH that can be used to deliver the L1 CSI report via for example, a BSR or an UL MAC-CE containing the CSI report. The L1 CSI report can be sent from the UE to the DU at 606. At 608, the UE may receive an L1 based HO command from the DU via such as for example, a DL MAC-CE.

In an example embodiment, if it is determined at 603 that the UE has an UL grant, the UE may send a BSR or/and an UL MAC-CE to the DU at 607. In an example embodiment, the BSR may have a designated LCG ID that indicates a pending CSI report. The BSR may indicate the pending CSI report with the designated LCG ID and may further use the corresponding buffer size field to provide L1 measurement information for the L1 based handover event to proceed. In an example embodiment, the buffer size field may be used to provide cell indication or beam indication that can uniquely identify the measured cell or beam, or provide further information of the pending CSI report to the gNB/DU. For example, the further information may include the CSI report, e.g., a full or part of a channel measurement metric such as RSRP or CQI, or an indication of the configured event triggering the report. In an example embodiment, the UL MAC-CE may include the CSI report, e.g., a full or part of a channel measurement metric such as RSRP or CQI, or an indication of the configured event triggering the report, or provide cell indication or beam indication that can uniquely identify the measured cell or beam. In an example embodiment, the BSR and the UL MAC-CE may be used in combination. For example, the BSR may indicate there is a CSI report pending and provide cell or beam indication, while the UL MAC-CE may include the CSI report. At 608, the UE may receive an L1 based HO command from the DU via such as for example, a DL MAC-CE.

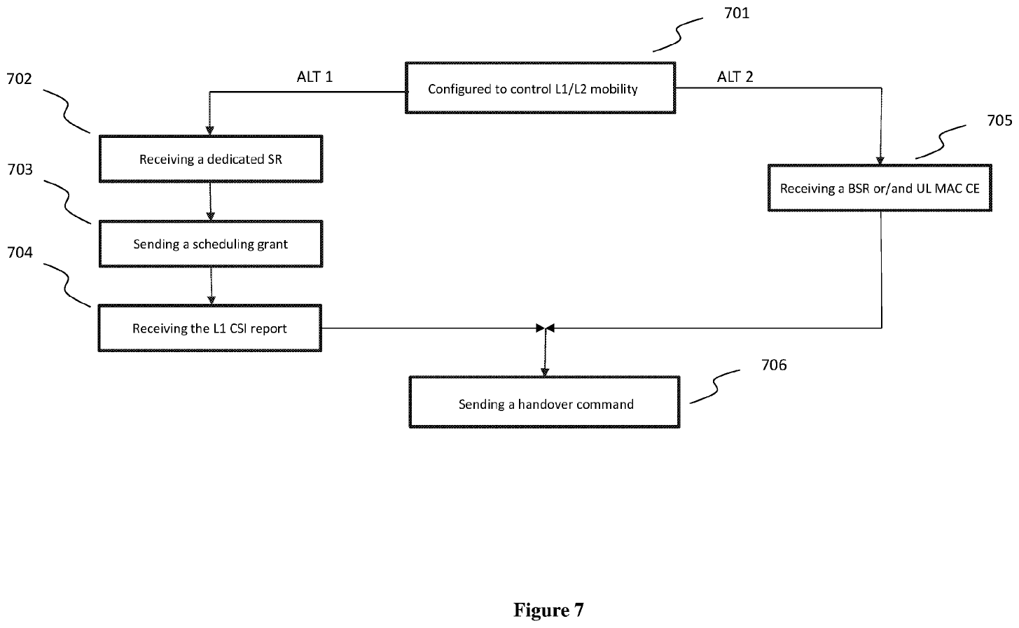

FIG. 7 describes a block diagram for some operation of a NE according to an example embodiment. In FIG. 7, at 701, a NE, such as for example, NE 101 of FIG. 1, the DU 403 of FIG. 4 or the DU 503 of FIG. 5, is configured to control L1/L2 mobility for a UE, such as for example, UE 102, 104, or 106 of FIG. 1, or UE 405 of FIG. 4, or UE 505 of FIG. 5. In an example embodiment as an alternative, the NE may at 702 receive a dedicated SR from the UE. The dedicated SR indicates an L1 CSI report, such as for example, an L1 RSRP measurement report, is pending. In an example embodiment, a dedicated LCG ID may be configured and when a SR identifies the dedicated LCG ID, it indicates there is a pending CSI report. In another example embodiment, a dedicated time/frequency domain resource may be configured for transmitting the SR indicating pending CSI report. At 703, in response to the received dedicated SR, the NE may send a scheduling grant to the UE. The scheduling grant may either trigger an aperiodic CSI request for the pending L1 CSI report, or perhaps schedule a PUSCH that can be used to deliver the L1 CSI report via for example, a BSR or an UL MAC-CE containing the CSI report. The L1 CSI report may be received from the UE at 704. At 706, based on the L1 CSI report, the NE may decide to perform a L1/L2 handover and send an L1 based HO command to the UE via such as for example, a DL MAC-CE.

In an example embodiment as another alternative, the NE may receive a BSR or/and an UL MAC-CE from the UE at 705. In an example embodiment, the BSR may have a designated LCG ID that indicates a pending CSI report. The BSR may indicate the pending CSI report with the designated LCG ID and may further use the corresponding buffer size field to provide L1 measurement information for the L1 based handover event to proceed. In an example embodiment, the buffer size field may be used to provide cell indication or beam indication that can uniquely identify the measured cell or beam, or provide further information of the pending CSI report to the gNB/DU. For example, the further information may include the CSI report, e.g., a full or part of a channel measurement metric such as RSRP or CQI, or an indication of the configured event triggering the report. In an example embodiment, the UL MAC-CE may include the CSI report, e.g., a full or part of a channel measurement metric such as RSRP or CQI, or an indication of the configured event triggering the report, or provide cell indication or beam indication that can uniquely identify the measured cell or beam. In an example embodiment, the BSR and the UL MAC-CE may be used in combination. For example, the BSR may indicate there is a CSI report pending and provide cell or beam indication, while the UL MAC-CE may include the CSI report. At 706, based on the L1 CSI report carried in the BSR or/and the UL MAC-CE, the NE may decide to perform a L1/L2 handover and send an L1 based HO command to the UE via such as for example, a DL MAC-CE.

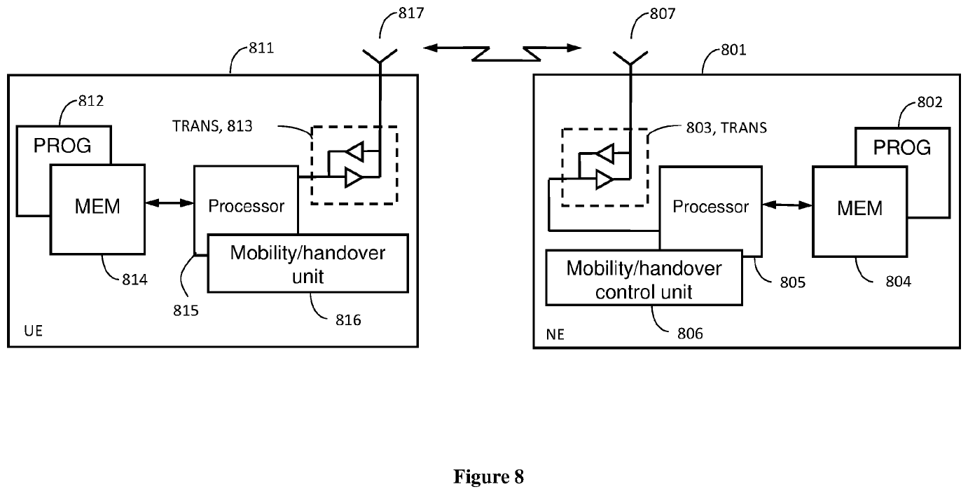

Reference is made to FIG. 8 for illustrating a simplified block diagram of various example apparatuses that are suitable for use in practicing various example embodiments of this application. In FIG. 8, a network element, NE, 801, such as for example, the NE 101 of FIG. 1, is adapted for communication with a UE 811, such as for example, the UE 102, 104 or 106 of FIG. 1. The UE 811 includes at least one processor 815, at least one memory, MEM, 814 coupled to the at least one processor 815, and a suitable transceiver, TRANS, 813 (having a transmitter, TX, and a receiver, RX) coupled to the at least one processor 815. The at least one MEM 814 stores a program, PROG, 812. The TRANS 813 may include or be coupled to one or more antennas 817 and is for bidirectional wireless communications with the NE 801.

The NE 801 includes at least one processor 805, at least one MEM 804 coupled to the at least one processor 805, and a suitable TRANS 803 (having a TX and a RX) coupled to the at least one processor 805. The at least one MEM 804 stores a PROG 802. The TRANS 803 may include or be coupled to one or more antennas 807 and is for bidirectional wireless communications with the UE 811. The NE 801 may be coupled to one or more cellular networks or systems, which is not shown in this figure.

As shown in FIG. 8, the NE 801 may further include a mobility/handover control unit 806. The unit 806, together with the at least one processor 805 and the PROG 802, may be utilized by the NE 801 in conjunction with various example embodiments of the application, as described herein.

As shown in FIG. 8, the UE 811 may further include a mobility/handover unit 816. The unit 816, together with the at least one processor 815 and the PROG 812, may be utilized by the UE 811 in conjunction with various example embodiments of the application, as described herein.

In general, the various example embodiments of the apparatus 801 can include a node, host, or server in a communications network or serving such a network. For example, apparatus 801 may be a network node, satellite, base station, a Node B, an evolved Node B, eNB, 5G Node B or access point, next generation Node B, NG-NB or gNB, or a WLAN access point, associated with a radio access network, such as a LTE, 5G or NR network.

It should be understood that, in some example embodiments, apparatus 801 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 801 represents a gNB, it may be configured in a central unit, CU, and distributed unit, DU, architecture that divides the gNB functionality. In such an architecture, the CU may be a logical node that includes gNB functions such as transfer of user data, mobility control, radio access network sharing, positioning, or session management, etc. The CU may control the operation of DU(s) over a front-haul interface. The DU may be a logical node that includes a subset of the gNB functions, depending on the functional split option. In another example, a gNB may comprise multiple TRPs. It should be noted that one of ordinary skill in the art would understand that apparatus 801 may include components or features not shown in FIG. 8.

In general, the various example embodiments of the apparatus 811 can include, but are not limited to, cellular phones, personal digital assistants having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. In an embodiment, apparatus 811 may be a node or element in a communications network or associated with such a network, such as a UE, mobile equipment, ME, mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display, a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 811 may be implemented in, for instance, a wireless handheld device, a wireless plug-in accessory, or the like. It should be noted that one of ordinary skill in the art would understand that apparatus 811 may include components or features not shown in FIG. 8.

The example embodiments of this disclosure may be implemented by computer software or computer program code executable by one or more of the processors 805, 815 of the NE 801 and the UE 811, or by hardware, or by a combination of software and hardware.

At least one of the PROGs 802 and 812 is assumed to include program instructions that, when executed by the associated processor, enable the electronic apparatus to operate in accordance with the example embodiments of this disclosure, as discussed herein.

The TRANS 803 and 813 may include, for example, a plurality of radio interfaces that may be coupled to the antenna(s) 807 and 817, respectively. The radio interfaces may correspond to a plurality of radio access technologies including one or more of GSM, WCDMA, NB-IoT, LTE, 5G, WLAN, Bluetooth, BT-LE, NFC, radio frequency identifier, ultrawideband, MulteFire, and the like. The radio interface may include components, such as filters, converters (for example, digital-to-analog converters and the like), mappers, a Fast Fourier Transform module, and the like, to generate symbols for a transmission and to receive symbols. As such, TRANS 803 and 813 may be configured to modulate information on to a carrier waveform for transmission by the antenna(s) and demodulate information received via the antenna(s) for further processing by other elements of apparatus 801 and 811, respectively. In other embodiments, TRANS 803 and 813 may be capable of transmitting and receiving signals or data directly. Additionally or alternatively, in some embodiments, apparatus 801 and/or 811 may include an input and/or output device.

The MEMs 804 and 814 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. For example, memory 804 and 814 can be comprised of any combination of random access memory, read only memory, static storage such as a magnetic or optical disk, hard disk drive, or any other type of non-transitory machine or computer readable media. The instructions stored in memory 804 or 814 may include program instructions or computer program code that, when executed by processor 805 or 815, enable the apparatus 801 or 811 to perform tasks as described herein.

In an embodiment, apparatus 801 or 811 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 805/815 or apparatus 801/811.

The processors 805 and 815 may be of any type suitable to the local technical environment, and may include one or more of general purpose computers, special purpose computers, microprocessors, digital signal processors, field-programmable gate arrays, application-specific integrated circuits, and processors based on multi-core processor architecture, as non-limiting examples. While a single processor 805 and 815 is shown in NE and UE of FIG. 8, respectively, multiple processors may be utilized according to other embodiments. For example, it should be understood that, in certain embodiments, apparatus 801 or 811 may include two or more processors that may form a multiprocessor system (e.g., in this case processor 805 or 815 may represent a multiprocessor) that may support multiprocessing. In certain embodiments, the multiprocessor system may be tightly coupled or loosely coupled (e.g., to form a computer cluster).

Without in any way limiting the scope, interpretation, or application of the claims appearing below, technical effects of one or more of the example embodiments disclosed herein may be facilitating L1/L2 based inter-cell change by including cell identifier in the L1 CSI report, and optimized reporting of aperiodic L1 measurements to facilitate L1/L2 based HO.

The following are additional examples.

Example 1-1. A method, comprises: by a network element (NE), receiving from a UE at least one of a BSR or an UL MAC-CE; determining to perform an L1 based handover for the UE; and sending an L1 based handover command to the UE.

Example 1-2. The method of example 1-1, wherein the BSR may have a designated LCG ID that indicates a pending CSI report.

Example 1-3. The method of example 1-2, wherein a buffer size field of the BSR corresponding to the designated LCG ID includes L1 measurement information for the L1 based handover event to proceed.

Example 1-4. The method of example 1-3, wherein the L1 measurement information comprises at least one of an L1 CSI report, a cell indication or a beam indication that can uniquely identify the measured cell or beam.

Example 1-5. The method of any of examples 1-1 to 1-4, wherein the UL MAC-CE comprises at least one of an L1 CSI report, a cell indication or a beam indication that can uniquely identify the measured cell or beam.

Example 1-6. The method of example 1-4 or 1-5, wherein the L1 CSI report includes a full or part of a channel measurement metric, or an indication of a configured event triggering the L1 CSI report.

Example 1-7. The method of any of examples 1-1 to 1-6, wherein the determining to perform the L1 based handover is based on the received at least one of the BSR or the UL MAC-CE.

Example 1-8. The method of any of examples 1-1 to 1-7, further comprises receiving a dedicated SR from the UE. The dedicated SR indicates that an L1 CSI report is pending.

Example 1-9. The method of example 1-8, further comprises: in response to the received dedicated scheduling request, sending a scheduling grant to the UE. The scheduling grant may either trigger an aperiodic CSI request for the pending L1 CSI report, or perhaps schedule a data channel such as for example, PUSCH, which can be used to deliver the L1 CSI report.

Example 1-10. The method of any of examples 1-1 to 1-9, wherein the L1 CSI report includes a cell identifier that can uniquely identify the measured cell.

Example 1-11. The method of example 1-10, wherein the cell identifier is introduced as a separate field in the L1 CSI report, or integrated as part of the other field.

Example 1-12. The method of example 1-11, wherein the other field includes at least one of CRI or SSBRI.

Example 2-1. A method, comprises: by a user equipment (UE), receiving an L1/L2 mobility configuration; deciding that there is an L1 CSI report to send; determining whether the UE has an UL grant; if it is determined that the UE has an UL grant, the method further comprises: sending at least one of a BSR or an UL MAC-CE to a NE; if it is determined that the UE does not have an UL grant, the method further comprises: sending a dedicated SR to a NE indicating that an L1 CSI report is pending, receiving a scheduling grant from the NE, and sending the L1 CSI report to the NE based on the scheduling grant; and receiving an L1 based HO command from the NE.

Example 2-2. The method of example 2-1, wherein the BSR may have a designated LCG ID that indicates a pending L1 CSI report.

Example 2-3. The method of example 2-2, wherein a buffer size field of the BSR corresponding to the designated LCG ID includes L1 measurement information for the L1 based handover event to proceed.

Example 2-4. The method of example 2-3, wherein the L1 measurement information comprises at least one of an L1 CSI report, a cell indication or a beam indication that can uniquely identify the measured cell or beam.

Example 2-5. The method of any of examples 2-1 to 2-4, wherein the UL MAC-CE comprises at least one of an L1 CSI report, a cell indication or a beam indication that can uniquely identify the measured cell or beam.

Example 2-6. The method of example 2-4 or 2-5, wherein the L1 CSI report includes a full or part of a channel measurement metric, or an indication of a configured event triggering the L1 CSI report.

Example 2-7. The method of any of examples 2-1 to 2-6, wherein the scheduling grant may either trigger an aperiodic CSI request for the pending L1 CSI report, or perhaps schedule a data channel such as for example, PUSCH, which can be used to deliver the L1 CSI report.

Example 2-8. The method of any of examples 2-1 to 2-7, wherein the L1 CSI report includes a cell identifier that can uniquely identify the measured cell.

Example 2-9. The method of example 2-8, wherein the cell identifier is introduced as a separate field in the L1 CSI report, or integrated as part of the other field.

Example 2-10. The method of example 2-9, wherein the other field includes at least one of CRI or SSBRI.

Example 3-1. A computer program, comprising code for performing the methods of any of examples 1-1 to 2-10, when the computer program is run on a computer.

Example 3-2. The computer program according to example 3-1, wherein the computer program is a computer program product comprising a computer-readable medium bearing computer program code embodied therein for use with the computer.

Example 3-3. The computer program according to example 3-1, wherein the computer program is directly loadable into an internal memory of the computer.

Example 4-1. An apparatus, comprising means for performing the method of any of examples 1-1 to 2-10.

Example 4-2. The apparatus of example 4-1, wherein the means comprising: at least one processor; and at least one memory including computer program code, the at least one memory and computer program code configured to, with the at least one processor, cause the performance of the apparatus.

Example 5. A computer program product comprising a computer-readable storage medium bearing computer program code embodied therein for use with a computer, the computer program code comprising code for performing the method of any of examples 1-1 to 2-10.

Embodiments of the present invention may be implemented in software, hardware, application logic or a combination of software, hardware and application logic. The software, application logic and/or hardware may reside on an apparatus such as a user equipment, a gNB or other mobile communication devices. If desired, part of the software, application logic and/or hardware may reside on a NE 801, part of the software, application logic and/or hardware may reside on a UE 811, and part of the software, application logic and/or hardware may reside on other chipset or integrated circuit. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a non-transitory computer-readable storage medium that may be any media or means that can contain or store the instructions for use by or in connection with an instruction execution system, apparatus, or device.

It is also noted herein that while the above describes example embodiments of the invention, these descriptions should not be viewed in a limiting sense. Rather, there are several variations and modifications which may be made without departing from the scope of the present invention.

Further, the various names used for the described parameters are not intended to be limiting in any respect, as these parameters may be identified by any suitable names. If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

What is claimed is:

1. A method, comprising:
receiving from a UE at least one of a BSR or an uplink MAC-CE;
determining to perform an L1 based handover for the UE; and
sending an L1 based handover command to the UE.

2. The method as in claim 1, wherein the BSR includes a designated LCG ID that indicates a pending L1 CSI report.

3. The method as in claim 2, wherein a buffer size field of the BSR corresponding to the designated LCG ID includes L1 measurement information for the L1 based handover event to proceed.

4. The method as in claim 3, wherein the L1 measurement information comprises at least one of an L1 CSI report, a cell indication or a beam indication that can uniquely identify the measured cell or beam.

5. The method as in any of claims 1 to 4, wherein the UL MAC-CE comprises at least one of an L1 CSI report, a cell indication or a beam indication that can uniquely identify the measured cell or beam.

6. The method as in claim 4 or 5, where the L1 CSI report includes a full or part of a channel measurement metric, or an indication of a configured event triggering the L1 CSI report.

7. The method as in any of claims 1 to 6, wherein the determining to perform the L1 based handover is based on the received at least one of the BSR or the uplink MAC-CE.

8. The method as in any of claims 1 to 7, further comprising:
receiving from the UE a dedicated scheduling request indicating that an L1 CSI report is pending.

9. The method as in claim 8, further comprising:
in response to the received dedicated scheduling request, sending a scheduling grant to the UE, wherein the scheduling grant either triggers an aperiodic CSI request for the pending L1 CSI report, or schedules a data channel that can be used to deliver the L1 CSI report.

10. The method as in any of claims 1 to 9, wherein the L1 CSI report includes a cell identifier that can uniquely identify the measured cell.

11. The method as in claim 10, wherein the cell identifier is introduced as a separate field in the L1 CSI report, or integrated as part of the other field.

12. The method as in claim 11, wherein the other field includes at least one of CRI or SSBRI.

13. An apparatus, comprising:
at least one processor; and
at least one memory including computer program code;
the at least one memory and the computer program code configured to cause the apparatus at least to:
receive from a UE at least one of a BSR or an uplink MAC-CE;
determine to perform an L1 based handover for the UE; and
send an L1 based handover command to the UE.

14. The apparatus as in claim 13, wherein the BSR includes a designated LCG ID that indicates a pending L1 CSI report.

15. The apparatus as in claim 14, wherein a buffer size field of the BSR corresponding to the designated LCG ID includes L1 measurement information for the L1 based handover event to proceed.

16. The apparatus as in claim 15, wherein the L1 measurement information comprises at least one of an L1 CSI report, a cell indication or a beam indication that can uniquely identify the measured cell or beam.

17. The apparatus as in any of claims 13 to 16, wherein the UL MAC-CE comprises at least one of an L1 CSI report, a cell indication or a beam indication that can uniquely identify the measured cell or beam.

18. The apparatus as in claim 16 or 17, where the L1 CSI report includes a full or part of a channel measurement metric, or an indication of a configured event triggering the L1 CSI report.

19. The apparatus as in any of claims 13 to 18, wherein when determining to perform the L1 based handover, the at least one memory and the computer program code configured to cause the apparatus to determine based on the received at least one of the BSR or the uplink MAC-CE.

20. The apparatus as in any of claims 13 to 19, wherein the at least one memory and the computer program code configured to cause the apparatus to:
receive from the UE a dedicated scheduling request indicating that an L1 CSI report is pending.

21. The apparatus as in claim 20, wherein the at least one memory and the computer program code configured to cause the apparatus to:
in response to the received dedicated scheduling request, send a scheduling grant to the UE, wherein the scheduling grant either triggers an aperiodic CSI request for the pending L1 CSI report, or schedules a data channel that can be used to deliver the L1 CSI report.

22. The apparatus as in any of claims 13 to 21, wherein the L1 CSI report includes a cell identifier that can uniquely identify the measured cell.

23. The apparatus as in claim 22, wherein the cell identifier is introduced as a separate field in the L1 CSI report, or integrated as part of the other field.

24. The apparatus as in claim 23, wherein the other field includes at least one of CRI or SSBRI.

25. A method, comprising:
by a UE,
receiving an L1/L2 mobility configuration;
deciding that there is an L1 CSI report to send;
determining whether the UE has an UL grant;
if it is determined that the UE has an UL grant, the method further comprises:
sending at least one of a BSR or an UL MAC-CE to a NE;
if it is determined that the UE does not have an UL grant, the method further comprises:
sending a dedicated SR to a NE indicating that an L1 CSI report is pending;
receiving a scheduling grant from the NE; and
sending the L1 CSI report to the NE based on the scheduling grant; and
receiving an L1 based handover command from the NE.

26. The method as in claim 25, wherein the BSR includes a designated LCG ID that indicates a pending L1 CSI report.

27. The method as in claim 26, wherein a buffer size field of the BSR corresponding to the designated LCG ID includes L1 measurement information for the L1 based handover event to proceed.

28. The method as in claim 27, wherein the L1 measurement information comprises at least one of an L1 CSI report, a cell indication or a beam indication that can uniquely identify the measured cell or beam.

29. The method as in any of claims 25 to 28, wherein the UL MAC-CE comprises at least one of an L1 CSI report, a cell indication or a beam indication that can uniquely identify the measured cell or beam.

30. The method as in claim 28 or 29, where the L1 CSI report includes a full or part of a channel measurement metric, or an indication of a configured event triggering the L1 CSI report.

31. The method as in any of claims 25 to 30, wherein the scheduling grant either triggers an aperiodic CSI request for the pending L1 CSI report, or schedules a data channel that can be used to deliver the L1 CSI report.

32. The method as in any of claims 25 to 31, wherein the L1 CSI report includes a cell identifier that can uniquely identify the measured cell.

33. The method as in claim 32, wherein the cell identifier is introduced as a separate field in the L1 CSI report, or integrated as part of the other field.

34. The method as in claim 33, wherein the other field includes at least one of CRI or SSBRI.

35. An apparatus, comprising:
at least one processor; and
at least one memory including computer program code;
the at least one memory and the computer program code configured to cause the apparatus at least to:
receive an L1/L2 mobility configuration;
decide that there is an L1 CSI report to send;
determine whether the apparatus has an UL grant;
if it is determined that the apparatus has an UL grant, the at least one memory and the computer program code configured to cause the apparatus at least to:
send at least one of a BSR or an UL MAC-CE to a NE;
if it is determined that the UE does not have an UL grant, the at least one memory and the computer program code configured to cause the apparatus at least to:
send a dedicated SR to a NE indicating that an L1 CSI report is pending;
receive a scheduling grant from the NE; and
send the L1 CSI report to the NE based on the scheduling grant; and
receive an L1 based handover command from the NE.

36. The apparatus as in claim 35, wherein the BSR includes a designated LCG ID that indicates a pending L1 CSI report.

37. The apparatus as in claim 35 or 36, wherein a buffer size field of the BSR corresponding to the designated LCG ID includes L1 measurement information for the L1 based handover event to proceed.

38. The apparatus as in claim 37, wherein the L1 measurement information comprises at least one of an L1 CSI report, a cell indication or a beam indication that can uniquely identify the measured cell or beam.

39. The apparatus as in any of claims 35 to 38, wherein the UL MAC-CE comprises at least one of an L1 CSI report, a cell indication or a beam indication that can uniquely identify the measured cell or beam.

40. The apparatus as in claim 38 or 39, where the L1 CSI report includes a full or part of a channel measurement metric, or an indication of a configured event triggering the L1 CSI report.

41. The apparatus as in any of claims 35 to 40, wherein the scheduling grant either triggers an aperiodic CSI request for the pending L1 CSI report, or schedules a data channel that can be used to deliver the L1 CSI report.

42. The apparatus as in any of claims 35 to 41, wherein the L1 CSI report includes a cell identifier that can uniquely identify the measured cell.

43. The apparatus as in claim 42, wherein the cell identifier is introduced as a separate field in the L1 CSI report, or integrated as part of the other field.

44. The apparatus as in claim 43, wherein the other field includes at least one of CRI or SSBRI.

45. A computer program product including a non-transitory computer-readable storage medium and storing executable code that, when executed by at least one apparatus, is configured to cause the at least one apparatus to perform a method of any of claims 1 to 12, and 25 to 34.

46. An apparatus comprising means for performing a method according to any of claims 1 to 12, and 25 to 34.
